(19) United States
(12) Patent Application Publication
(10) Pub. No.: US 2009/0052745 A2
(43) Pub. Date: Feb. 26, 2009

(54) PERSONAL IDENTIFICATION SYSTEM

(75) Inventor: Anwar SATHATH, Tokyo (JP)

Correspondence Address: PILLSBURY WINTHROP SHAW PITTMAN, LLP, P.O. BOX 10500, MCLEAN, VA, 22102, UNITED STATES, 703-770-7900, 703-770-7901

(73) Assignee: KABUSHIKI KAISHA TOSHIBA, Tokyo (JP)

(21) Appl. No.: 11/342,683

(22) Filed: Jan. 31, 2006

(30) Foreign Application Priority Data
Jan. 31, 2005 (JP) 2005024456

(51) Int. Cl. G06K 9/00

(52) U.S. Cl. 382/115; 902/3

(57) ABSTRACT

According to the embodiment, there is provided a personal identification system including: a storage unit that stores previously registered personal information and biometric information; an input unit for inputting personal information and biometric information; a determination unit that determines whether or not the personal information input in the input unit coincides with the previously registered personal information; a temporary cryptographic key generation unit that generates a temporary cryptographic key when the determination unit determines that the input personal information coincides with the previously registered personal information; an encryption unit that encrypts, with the temporary cryptographic key, the biometric information input in the input unit to generate biometric information data; a decryption unit that decrypts the biometric information data with the temporary cryptographic key into the biometric information; and an identification unit that validates the decrypted biometric information with the previously registered biometric information to perform personal identification.

### CROSS-REFERENCE TO RELATED APPLICATIONS

This application is based upon and claims the benefit of priority from Japanese Patent Application No. 2005-024456, filed on Jan. 31, 2005, the entire contents of which are incorporated herein by reference.

### BACKGROUND

1. Field

One embodiment of the invention relates to a personal identification system for performing personal identification using biometric information (biometrics), an identification apparatus for use in the personal identification system, and a personal identification method.

2. Description of the Related Art

In recent years, computers or cellular phones have been introduced into social systems broadly, and further with popularization of the Internet, electronic commercial transactions, card payments, accesses to in-house systems, and so on, have been able to be carried out easily through personal computer terminals or the like. On the other hand, security countermeasures have been regarded as important in order to prevent illegal accesses to service provision servers. Identification systems for identifying users with their user IDs or ID cards and passwords have been generally used.

However, there has been a problem that another person may impersonate a user by illegal action such as tapping a password etc. through the Internet environment or forging an ID card, and perform an electronic commercial transaction or gain illegal access to an in-house system.

Recently, therefore, in order to secure higher security, personal identification using biometric information (biometrics) has been performed. The biometric information used by the personal identification is specific to the user. Therefore, the personal identification using biometric information can prevent others from performing illegal transactions etc., as compared with identification using an ID card or a password. In addition, there is another advantage that it is not necessary for the user to remember the password or carry the ID card with the user. Thus, it is likely that the personal identification using biometric information will be introduced into various systems.

On the other hand, personal biometric information is information specific to a user. The biometric information remains unchanged as long as the user lives. Unlike any password, however, the personal biometric information cannot be changed. There is a fear that the user cannot use any personal identification using the biometric information during the life of the user if the biometric information is stolen illegally. Particularly in the Internet environment, there is a risk that the biometric information may be stolen. That is, the biometric information is more difficult to forge and higher in convenience than any ID card, but there is a problem that personal identification itself cannot be performed using the biometric information once the biometric information is stolen. Therefore, there is a request for a personal identification system in which biometric information can be used for personal identification safely even in the Internet environment.

There has been proposed such an identification system in which personal identification using biometric information can be used safely even in the Internet environment. For example, there is proposed in Japanese Patent Application Publication (KOKAI) No. 2003-134107 that a personal identification system as follows. That is, in a terminal, a common key is generated from a history of biometric information transmitted in the past. Biometric information to be transmitted for identification is encrypted with the common key and transmitted to a service providing server. Also in the server, a common key is generated from a history of biometric information received in the past. The received encrypted biometric information is decrypted with the common key and checked with biometric information of a to-be-authenticated person registered in advance. Identification for access to the service providing server is performed based on the checking result.

In such a manner, a common key is generated from values of biometric information transmitted/received in the past whenever biometric information is transmitted. Biometric information required for identification is encrypted with the common key. Accordingly, there can be obtained an effect that biometric information required for identification can be delivered safely by communication.

In the background-art personal identification system, a past transmission history is required for generation of a common key. The identification system cannot be applied to any other personal identification than identification for access from specified terminals. Thus, the identification system cannot be applied to identification for access from other computers (unspecified number of terminals such as Internet cafe terminals), cellular phones, etc.

Since the common key to encrypt biometric information is generated in the terminal, when the terminal is stolen or the past transmission history disappears due to failure of the terminal, identification cannot be performed though biometric information was present in the terminal.

Further, it is necessary to store data of the past transmission history in the terminal. Thus, the load on the terminal increases due to identification.

### SUMMARY

According to an embodiment of the invention, there is provided at least one of the followings.

(1) A personal identification system including: a storage unit that stores previously registered personal information and biometric information of a user; an input unit for inputting personal information and biometric information of the user; a determination unit that determines whether or not the personal information input in the input unit coincides with the previously registered personal information stored in the storage unit; a temporary cryptographic key generation unit that generates a temporary cryptographic key when the determination unit determines that the input personal information coincides with the previously registered personal information; an encryption unit that encrypts, with the temporary cryptographic key, the biometric information input in the input unit to generate biometric information data; a decryption unit that decrypts the biometric information data with the temporary cryptographic key into the biometric information; and an identification unit that validates the decrypted biometric information with the previously registered biometric information to perform personal identification.

(2) A personal identification system including: a server that performs personal identification based on biometric information of a user previously registered in a storage unit; and an operation terminal that communicates with the server and is provided with an input unit to be operated by the user, wherein the operation terminal encrypts biometric information of the user input through the input unit with a temporary cryptographic key that is transmitted from the server to generate encrypted data, and transmits the encrypted data to the server, and wherein the server decrypts the encrypted data with the temporary cryptographic key, validates the decrypted biometric information with the previously registered biometric information to perform personal identification, and transmits a result of the personal identification to the operation terminal.

(3) A personal identification method for performing personal identification based on previously registered personal information and biometric information of a user, the method including: requesting to input personal information of the user in response to a personal identification request made by the user; acquiring the personal information of the user; determining whether or not the acquired personal information coincides with the previously registered personal information; generating a temporary cryptographic key and determining identification conditions from among the previously registered biometric information when determined that the acquired personal information coincides with the previously registered personal information; requesting to input biometric information conforming to the identification conditions; acquiring the biometric information conforming to the identification conditions; encrypting the acquired biometric information with the temporary cryptographic key to generate encrypted data; decrypting the encrypted data with the temporary cryptographic key to acquire the biometric information; and validating the decrypted biometric information with the previously registered biometric information to perform personal identification.

According to the embodiment, a temporary cryptographic key from a server is used so that biometric information required for identification can be exchanged with higher security by communication. Thus, the convenience can be further improved.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic diagram showing the configuration of a personal identification system according to an embodiment;

FIG. 2 is an exemplary chart showing a process flow of personal identification in the personal identification system according to the embodiment;

FIG. 3 is an exemplary flow chart showing a personal identification process in a service providing server for use in the personal identification system according to the embodiment;

FIG. 4 is an exemplary flow chart showing a personal identification process in a service providing server for use in a personal identification system according to another embodiment; and

FIG. 5 is an exemplary diagram for explaining a table structure of biometric information stored in a registered biometric information DB according to an embodiment.

### DETAILED DESCRIPTION

Various embodiments according to the invention will be described hereinafter with reference to the accompanying drawings.

A personal identification system according to an embodiment of the invention, a server for use in the personal identification system, and a personal identification method will be described below in detail with reference to the drawings. In this embodiment, the invention is applied to a personal identification system in which personal identification is performed between a computer terminal (hereinafter referred to as “computer”) and a server for providing services (hereinafter referred to as “service providing server”) by way of example.

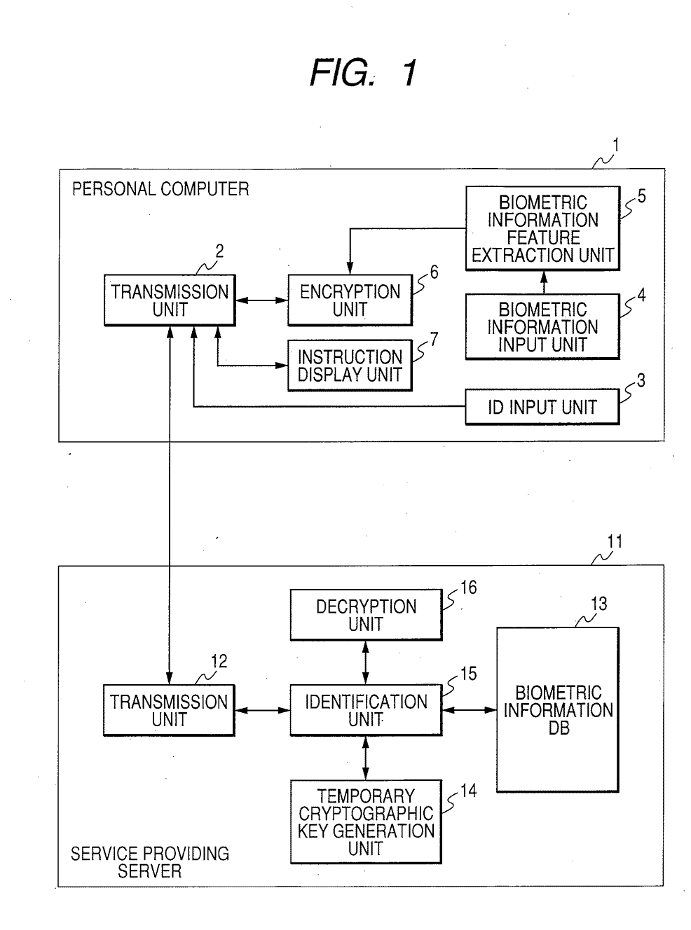

First, the outline of the configuration of the personal identification system will be described with reference to FIG. 1. FIG. 1 is a schematic view showing the configuration of a personal identification system according to an embodiment of the invention. A computer 1 and a service providing server 11 are connected via an open network such as the Internet so that they can exchange information.

The computer 1 is provided with a transmission unit 2, an instruction display unit 7 and an ID input unit 3. The transmission unit 2 is connected to the Internet and serves to transmit input information or receive information from the service providing server 11. The instruction display unit 7 serves to display information (for example, identification conditions) obtained from the service providing server through thetransmissionunit 2, so as to notify a user of the information. The ID input unit 3 serves to input a user ID or a password therewith. Here, the ID input unit 3 may have a card insertion portion (not shown) in which an ID card or the like can be inserted.

Further, the computer 1 is provided with a biometric information input unit 4, a biometric information feature extraction unit 5 and an encryption unit 6. The biometric information input unit 4 serves to input biometric information (biometrics) such as a fingerprint, an iris or a face image therewith. The biometric information feature extraction unit 5 serves to extract feature portions from the input biometric information so as to generate biometric information feature extracted data. The encryption unit 6 serves to encrypt the biometric information feature extracted data with a temporary cryptographic key generated by the service providing server and obtained through the transmission unit, so as to generate encrypted data.

Here, the biometric information input unit 4 has a miniature video camera or the like for photographing a portion (such as a fingerprint) of a body to be used for personal identification.

Further, for example, in the case of a fingerprint, the biometric information feature extracted data are data or digitalized data of feature points (branch points and end points) of the fingerprint or a relative position and a direction of a center point of the fingerprint. In the case of an iris, the biometric information feature extracted data are data or coded data expressing the light and shade of an iris pattern (iris pattern drawn radially) in each of a plurality of regions divided in the radial direction and in the rotational direction in advance in polar coordinates with the center of the iris as an origin. That is, the biometric information feature extraction unit 5 serves to extract biometric information features from the fingerprint or the like as biometric information feature extracted data using the data or digitalized data of feature points or directional properties of the biometric information.

The service providing server 11 has a transmission unit 12 and a biometric information database (DB) 13. The transmission unit 12 serves to receive input information from the computer 1 or transmit information generated by the service providing server 11. The biometric information DB 13 stores at least personal information including a user ID, a password, etc. of a user and biometric information of the user.

The service providing server 11 further includes an identification control unit 15, a temporary cryptographic key generation unit 14 and a decryption unit 16. When information such as a user ID, a password, etc. by which a person can be identified is received from the computer 1 through the transmission unit 12, the identification control unit 15 determines whether the received information coincides with the personal information recorded in the biometric information DB 13 or not. When the received information coincides with the personal information, the temporary cryptographic key generation unit 14 generates a temporary cryptographic key. When encrypted data are received from the computer 1, the decryption unit 16 decrypts the encrypted data with the temporary cryptographic key generated by the temporary cryptographic key generation unit 14, so as to decrypt the biometric information feature extracted data.

Further, to perform personal identification, the identification unit 15 determines whether the decrypted biometric information feature extracted data coincide with the biometric information feature extracted data stored in the biometric information DB 13 and corresponding to the personal information or not. When the decrypted biometric information feature extracted data coincide with the stored biometric information feature extracted data, the result of identification is registered in the identification unit 15, and transmitted to the computer 1 through the transmission unit 12. The result of identification is displayed on the instruction display unit 7 of the computer 1. When the result of identification is OK (the case where the personal identification is successful), the user is allowed to substantially communicate with the service providing server 11. Thus, for example, the user can perform an electronic commercial transaction, or when the service providing server 11 is an in-house system server, the user is permitted to gain access to the in-house system. On the contrary, when the result of identification is NG (the case where the personal identification is failed), the user is prohibited from gaining more access to the service providing server. Thus, the user cannot make any substantial communication.

Here, the temporary cryptographic key generation unit 14 serves to generate a temporary cryptographic key using a random number or the like. That is, the temporary cryptographic key generation unit 14 generates a temporary cryptographic key based on a random number generated as soon as an instruction to generate a temporary cryptographic key is given, for example, as soon as the user makes a request to the service providing server 11 for a transaction or as soon as it is concluded that the received personal information coincides with the personal information recorded in the biometric information DB 13.

Therefore, even if the same user gains access to the same service providing server, the same temporary cryptographic key will never be used again. Further, for example, a temporary cryptographic key used for encrypting biometric information and a communication time may be associated with each other and stored in the biometric information DB 13 or the like together with the personal information of a person during an identification process for the person, so that the same temporary cryptographic key as the temporary cryptographic key used for encrypting the biometric information can be used for decrypting the biometric information.

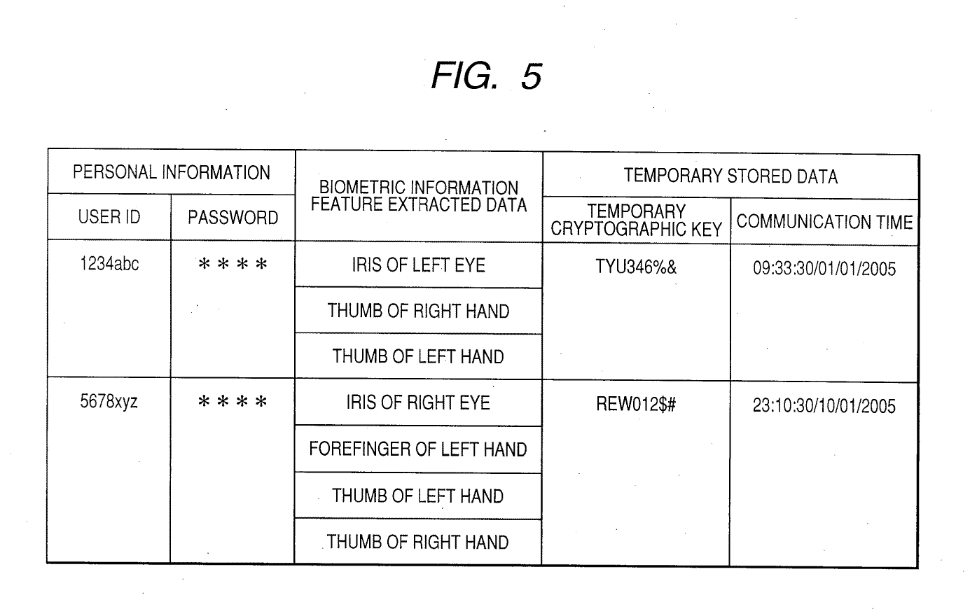

The configuration of a registered biometric information table stored in the biometric information DB in the personal identification system will be described here with reference to FIG. 5. FIG. 5 is a diagram for explaining the structure of a table of biometric information stored in the registered biometric information DB in an embodiment of the invention.

This table has fields of personal information including a user ID and a password, biometric information, a temporary cryptographic key, a communication time, etc. in each entry of data. The personal information may include not only the user ID and the password but also a name, an address, a phone number, an E-mail address, etc. registered as additional personal information. Alternatively, the user can register a plurality of desired pieces of biometric information in the form of biometric information feature extracted data, such as feature extracted data of a left iris, feature extracted data of a fingerprint of a thumb of a right hand, feature extracted data of a fingerprint of a thumb of a left hand, etc. When a plurality of pieces of biometric information are registered thus, identification conditions can be selected desirably so that an identification system higher in security can be realized.

When the temporary cryptographic key, the communication time, etc. to be used for encrypting biometric information feature extracted data or the like are stored temporally in association with the user ID, the temporary cryptographic key, the communication time, etc. can be used for decrypting the biometric information feature extracted data encrypted with the temporary cryptographic key used in response to an access request to the service providing server for a transaction or the like.

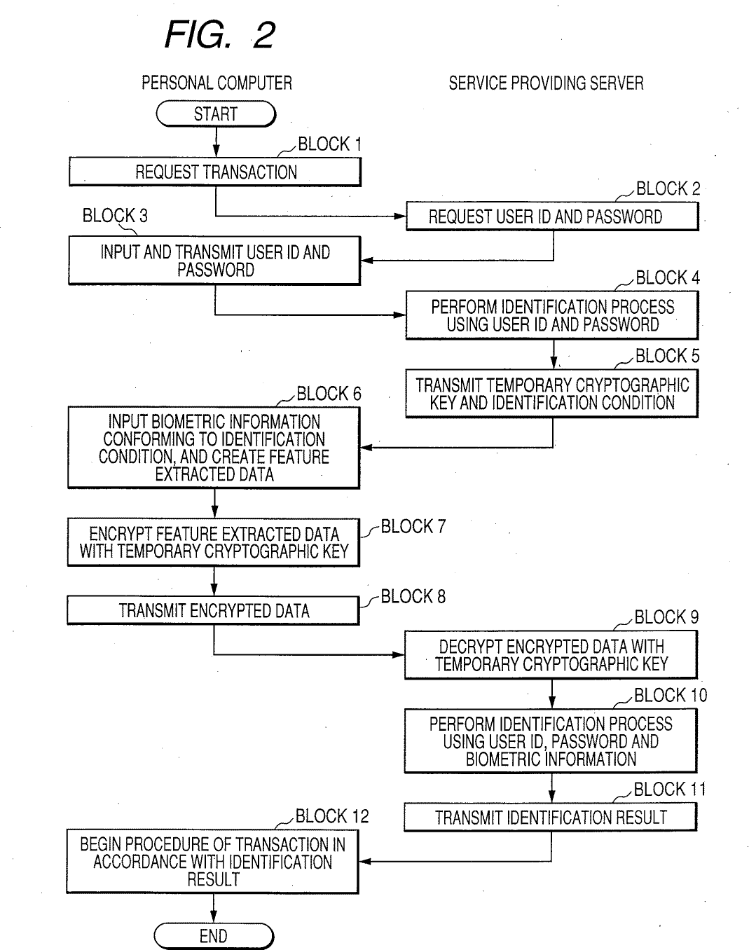

Next, a process flow in this personal identification system will be described with reference to FIG. 2. FIG. 2 is a chart showing a process flow of personal identification in the personal identification system according to the embodiment of the invention.

FIG. 2 is a chart for explaining an identification process for performing personal identification based on biometric information so as to permit a user to gain access to a service providing server in a personal identification system constituted by a personal computer serving as a terminal of the user and the service providing server.

First, the user issues a transaction request from a personal computer (terminal open to the public) installed in an Internet cafe or the like to a service providing server providing a specific service, for example, to a service providing server in order to perform an electronic commercial transaction with a server of a bank (BLOCK 1).

In response to the transaction request, the service providing server makes a transmission request for a user ID and a password to the personal computer having issued the transaction request (BLOCK 2). The request for the user ID and the password from the service providing server is displayed on the indication display unit 7 of the personal computer, for example, an LCD display portion or the like of the personal computer. Thus, the user is notified of the request for the user ID and the password.

In accordance with instructions of the service providing server, the user inputs the user ID and the password through the ID input unit 3, and transmits the user ID and the password to the service providing server through the transmission unit 2 (BLOCK 3).

The service providing server performs an identification process as to whether the personal information of the user ID and the password transmitted thereto coincides with the personal information registered in the biometric information DB 13 or not (BLOCK 4).

When the personal information transmitted from the personal computer coincides with the registered personal information, a temporary cryptographic key is generated by the temporary cryptographic key generation unit 14, and transmitted to the personal computer through the transmission unit 12 together with an identification condition (BLOCK 5). Here, the identification condition is selected desirably from a plurality of pieces of feature extracted data of biometric information registered in the biometric information DB by the identification unit 15, and transmitted through the transmission unit. For example, description will be made below on the assumption that the identification condition is a fingerprint of a thumb of a left hand. The identification condition from the service providing server is displayed on the instruction display unit 7. Thus, the user is notified of the identification condition.

In accordance with the identification condition displayed on the instruction display unit 7, the user inputs the fingerprint of the thumb of the left hand of the user through the biometric information input unit 4. The biometric information feature extraction unit 5 extracts feature portions of the input fingerprint of the thumb of the left hand and creates biometric information feature extracted data (BLOCK 6).

The encryption unit 6 encrypts the biometric information feature extracted data with the temporary cryptographic key transmitted from the service providing server (BLOCK 7). The encrypted data are transmitted to the service providing server through the transmission unit 2 (BLOCK 8).

In the service providing server, the decryption unit 16 decrypts the received encrypted data with the temporary cryptographic key so as to obtain the biometric information feature extracted data of the fingerprint of the thumb of the left hand (BLOCK 9). After that, the identification unit 15 determines whether the decrypted biometric information feature extracted data coincide with the biometric information feature extracted data registered in the biometric information DB 13 and corresponding to the user ID and the password of the user so as to perform personal identification (BLOCK 10). The result of the identification is transmitted to the personal computer through the transmission unit 12 (BLOCK 11).

On the personal computer side, the result of the identification is received through the transmission unit 2, and displayed, for example, on the instruction display unit 7 so as to inform the user thereof (BLOCK 12). When the result of the identification is OK (the case where the personal identification is successful), the access of the user to the service providing server is approved so that the user can perform an electronic commercial transaction officially. On the contrary, when the result of the identification is NG (the case where the personal identification is failed), the user is prohibited from gaining access to the service providing server. Thus, the user cannot perform any electronic commercial transaction.

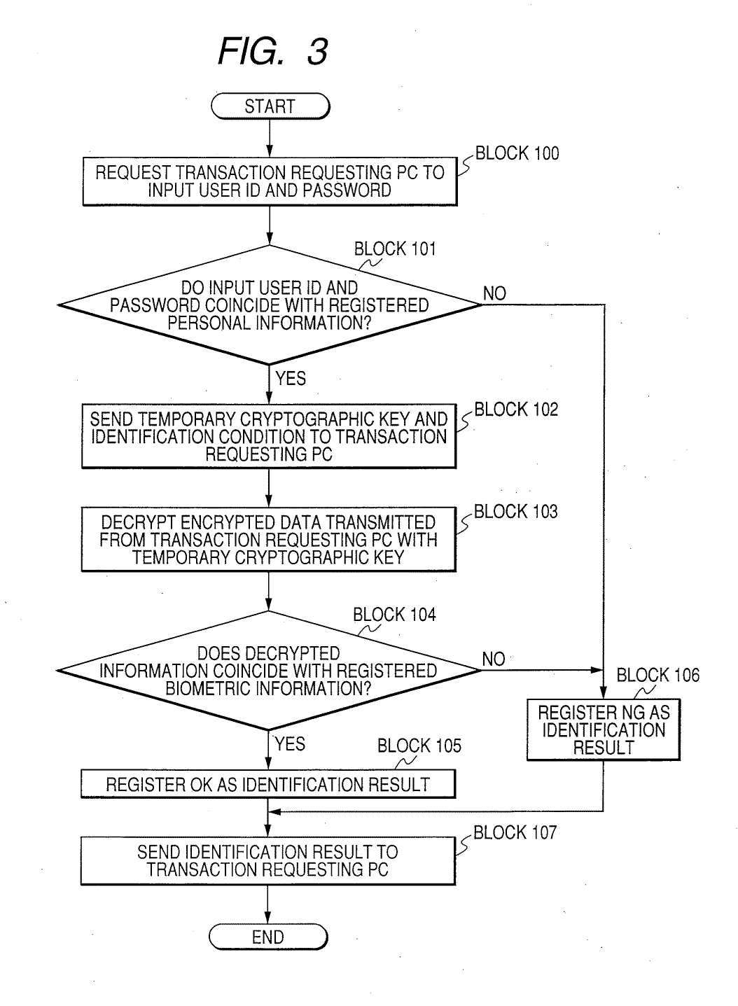

Here, the identification processing method in the service providing server used in the personal identification system will be described with reference to FIG. 3. FIG. 3 is a flow chart showing a personal identification process in the service providing server used in the personal identification system according to the embodiment of the invention.

Description will be made on the case where a user uses a personal computer to make a transaction request for an electronic commercial transaction to the service providing server through the Internet in FIG. 3. The personal computer making the transaction request and the service providing server can exchange information on the Internet via a phone line or the like by means of their transmission units.

First, when the user uses the personal computer to transmit a transaction request to the service providing server, the service providing server makes a request for input of a user ID and a password to the personal computer (user) making the transaction request (BLOCK 100).

Here, when the user inputs the user ID and the password in accordance with the request, the service providing server determines whether the input user ID and password coincide with a user ID and a password of personal information registered in the biometric information DB 13 or not (BLOCK 101).

When the input user ID and password do not coincide with the registered user ID and password, the service providing server registers NG (the case where personal identification is failed) as a result of identification (BLOCK 106). When the input user ID and password coincide with the registered user ID and password, the service providing server sends a temporary cryptographic key and an identification condition to the personal computer making the transaction request (BLOCK 102).

Here, the temporary cryptographic key is generated based on a random number generated as soon as it is concluded in BLOCK 101 that the input user ID and password coincide with the registered user ID and password. The generated temporary cryptographic key and a communication time thereof are stored temporarily in the biometric information DB 13 in association with the user ID.

Further, the identification condition can be decided desirably from a plurality of pieces of feature extracted data of biometric information registered in the biometric information DB 13. For example, description will be made on the case where the identification condition is a fingerprint of a thumb of a left hand.

In accordance with the identification condition, the user inputs the fingerprint of the thumb of the left hand of the user into the personal computer. The personal computer encrypts biometric information feature extracted data of the input biometric information with the temporary cryptographic key from the service providing server, and transmits the encrypted data to the service providing server.

The service providing server decrypts the transmitted encrypted data with the temporary cryptographic key stored in the biometric information DB 13 in association with the user ID (BLOCK 103). It is determined whether the decrypted biometric information feature extracted data coincide with the biometric information feature extracted data registered in the biometric information DB and corresponding to the registered personal information checked in BLOCK 101, that is, the registered fingerprint of the thumb of the left hand in this case, or not (BLOCK 104). When the decrypted biometric information feature extracted data do not coincide with the registered biometric information feature extracted data, NG (the case where the personal identification is failed) is registered as a result of identification (BLOCK 106). When the decrypted biometric information feature extracted data coincide with the registered biometric information feature extracted data, OK (the case where the personal identification is successful) is registered as a result of identification (BLOCK 105).

The result of identification is transmitted to the personal computer (user) making the transaction request (BLOCK 107). Here, when the result of identification is NG, the user is prohibited from gaining access to the service providing server. Thus, the user cannot perform any official electronic commercial transaction. On the contrary, when the result of identification is OK, the user is permitted to gain access to the service providing server. Thus, the user can perform an official electronic commercial transaction.

Here, in the description of this embodiment, only the biometric information to be exchanged is encrypted and decrypted with the temporary cryptographic key. However, a user ID and a password to be transmitted may be also encrypted and decrypted with a temporary cryptographic key generated by the service providing server. This temporary cryptographic key may be identical to the temporary cryptographic key to be used for the biometric information, or may be different therefrom.

In such a manner, in the personal identification system according to the embodiment and the service providing server for use in the personal identification system, first, primary personal identification is performed using personal information such as a user ID and a password. When the identification is successful, secondary personal identification using biometric information is performed. When the primary personal identification is failed, the identification process using the biometric information does not have to be performed. Thus, the service providing server does not have to use a memory or a hard disk for the identification process using the biometric information. It is therefore possible to reduce the load on the service providing server therefor.

In addition, when the primary personal identification is successful, a temporary cryptographic key is generated using a random number or the like by the service providing server, and transmitted to the personal computer (user) making a transaction request. The temporary cryptographic key is used for encrypting or decrypting biometric information feature extracted data. Thus, illegal actions such as tapping or forging can be prevented even when communication is made via an open network such as the Internet environment. It is therefore possible to improve the security of the personal identification system.

Further, a temporary cryptographic key is generated whenever an access request is received by the service providing server or whenever it is concluded that a user ID and a password transmitted from the personal computer coincide with a user ID and a password registered in the biometric information DB 13. There is no fear that the same temporary cryptographic key is used again. Even if the temporary cryptographic key is tapped, the temporary cryptographic key cannot be used again. Thus, the security can be improved. In addition, the temporary cryptographic key may be stored only in the service providing server temporarily (for example, till the personal computer decrypts the encrypted data transmitted thereto). Thus, the personal computer does not have to store or manage a past transmission history or a common cryptographic key as in the background-art example.

Accordingly, personal identification can be performed not only on specified personal computers or terminals but also on unspecified number terminals, such as personal computers in an Internet cafe. Thus, the convenience of the personal identification system is improved. Further, the cryptographic key does not have to be managed on the user side. Thus, only if the user remembers his/her user ID and password, the user can make a request for access to the service providing server easily from any place or from any terminal.

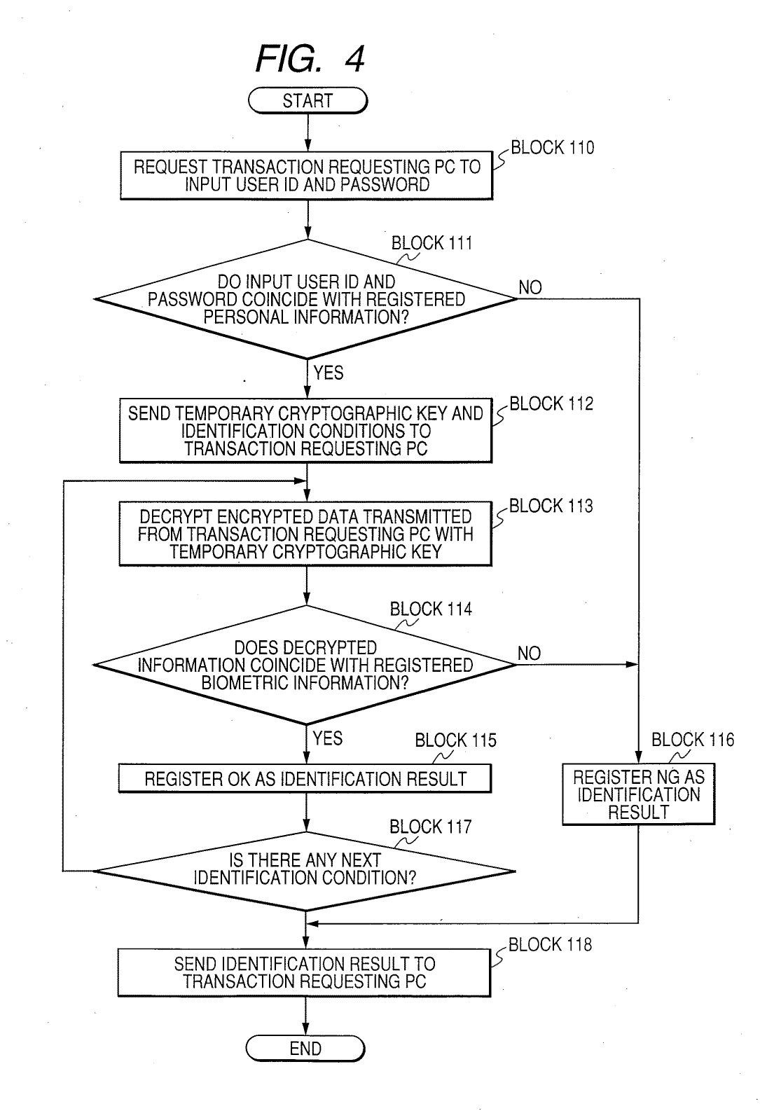

Next, an identification processing method according to another embodiment in the service providing server to be used in the personal identification system will be described with reference to FIG. 4. FIG. 4 is a flow chart showing a personal identification process in the service providing server in the personal identification system according to another embodiment of the invention. Here, FIG. 4 shows the case where a plurality of pieces of biometric information are designated as identification conditions.

In FIG. 4, description will be made on the case where a user uses a personal computer to make a transaction request for an electronic commercial transaction to the service providing server through the Internet in the same manner as in FIG. 3. The personal computer making the transaction request and the service providing server can exchange information on the Internet via a phone line or the like by means of their transmission units.

First, when the user uses the personal computer to transmit a transaction request to the service providing server, the service providing server makes a request for input of a user ID and a password to the personal computer (user) making the transaction request (BLOCK 110).

Here, when the user inputs the user ID and the password in accordance with the request, the service providing server determines whether the input user ID and password coincide with the user ID and password of the personal information registered in the biometric information DB 13 or not (BLOCK 111).

When the input user ID and password do not coincide with the registered user ID and password, the service providing server registers NG (the case where the personal identification is failed) as a result of identification. When the input user ID and password coincide with the registered user ID and password, the service providing server sends a temporary cryptographic key and identification conditions to the personal computer making the transaction request (BLOCK 112). Here, the identification conditions can be selected desirably. A plurality of pieces of biometric information may be used as the identification conditions. For example, a fingerprint of a thumb of a left hand is used as a first condition, and an iris of a left eye is used as a second condition. Description will be made below on the case of these identification conditions.

In accordance with the identification conditions, the user first inputs the fingerprint of the thumb of the left hand of the user into the personal computer as the first condition. In the personal computer, biometric information feature extracted data extracted from the input biometric information are encrypted with a temporary cryptographic key transmitted from the service providing server, and the encrypted data are transmitted to the service providing server.

The service providing server decrypts the transmitted encrypted data with the temporary cryptographic key (BLOCK 113). It is determined whether the decrypted biometric information feature extracted data coincide with the biometric information feature extracted data registered in the biometric information DB 13 and corresponding to the registered personal information checked in BLOCK 111 or not, that is, in this case, whether the decrypted biometric information feature extracted data coincide with the registered data of the fingerprint of the thumb of the left hand or not (BLOCK 114). When the decrypted data do not coincide with the registered data, NG (the case where the personal identification is failed) is registered as a result of identification (BLOCK 116). When the decrypted data coincide with the registered data, OK (the case where the personal identification is successful) is registered as a result of identification (BLOCK 115). The identification process so far is similar in contents to that in the description of FIG. 3.

Next, when the result of identification is OK, it is determined whether the next identification condition is present or not (BLOCK 117). When the second condition is present as in this embodiment, notification to input an iris of a left eye as the second condition is given to the user. The user inputs his/her left iris into the computer. In the personal computer, biometric information feature extracted data extracted from the input biometric information are encrypted with the temporary cryptographic key transmitted from the service providing server, and the encrypted data are transmitted to the service providing server.

The service providing server decrypts the transmitted encrypted data with the temporary cryptographic key (BLOCK 113). It is determined whether the decrypted biometric information feature extracted data coincide with the biometric information feature extracted data registered in the biometric information DB and corresponding to the registered personal information checked in BLOCK 111 or not, that is, in this case, whether the decrypted biometric information feature extracted data coincide with the registered data of the iris of the left eye or not (BLOCK 114). When the decrypted data do not coincide with the registered data, NG (the case where the personal identification is failed) is registered as a result of identification (BLOCK 116). When the decrypted data coincide with the registered data, OK (the case where the personal identification is successful) is registered as a result of identification (BLOCK 115).

The same identification method as that for the fingerprint of the thumb of the left hand as the first condition is repeated thus. Next, when the result of identification is OK, it is determined whether the next identification condition is present or not (BLOCK 117). The next identification condition is absent in this embodiment. Thus, the result of identification is sent to the personal computer making the transaction request (BLOCK 118).

Here, when the result of identification is NG, the user is prohibited from gaining access to the service providing server. Thus, the user cannot perform any official electronic commercial transaction. On the contrary, when the result of identification is OK, the user is permitted to gain access to the service providing server. Thus, the user can perform an official electronic commercial transaction.

Here, description has been made on the case where two pieces of biometric information are used as identification conditions in this embodiment. However, three, four or a desired number of pieces of biometric information may be decided as identification conditions if they have been registered. In addition, in this embodiment, a temporary cryptographic key and identification conditions are transmitted only once, and the temporary cryptographic key is used for encrypting and decrypting a plurality of pieces of biometric information feature extracted data. However, the temporary cryptographic key may be changed for each piece of biometric information. In such a manner, personal identification can be performed with higher security.

In such a manner, in the service providing server or the personal identification system using the same according to this embodiment, in addition to the aforementioned operation and effect described in FIG. 3, a plurality of pieces of biometric information are used as identification conditions so that personal identification can be performed with higher security even if one of the pieces of biometric information is tapped.

The aforementioned embodiments have been described on the case where a personal computer is used as a terminal. However, the terminal does not have to be a personal computer. Any apparatus such as a cellular phone, a PDA, an ATM machine or the like may be used as the terminal if it can exchange data and includes some kind of display unit and a biometric information input/encryption section constituted by an input unit for inputting biometric information, a password and an ID card, a biometric information feature extraction unit and an encryption unit.

Further, the biometric information input/encryption section does not have to be equipped or installed in a body of a personal computer or the like. The biometric information input/encryption section may be formed as a separate unit. When the biometric information input/encryption section is a separate unit, even a personal computer or the like having none of the biometric information input/encryption section can be used in the personal identification system.

Further, the service providing server is provided with an identification processing portion constituted by a biometric information DB, a decryption unit, an identification unit and a temporary cryptographic key generation unit in the aforementioned embodiments. However, the identification processing portion may be provided in an identification server separated from the service providing server so that a personal identification process is performed in the identification server. When the identification server is used thus, any user does not have to register personal information and biometric information for each service providing server such as a server of a bank, a server of an insurance company, etc. Once the user registers the personal information and the biometric information into the identification server, the user will be permitted to gain access to any registered service providing server if personal identification is successful. Thus, the convenience is improved.

In addition, when the identification server is provided separately from the service providing server, it is not necessary for the service providing server to use any program for processing personal identification or any memory therefor. Thus, the load on the service providing server due to the personal identification process can be reduced.

In addition, the aforementioned embodiments include various stages of the invention. Various stages of the invention can be extracted by desired combinations of a plurality of disclosed constituents or a plurality of disclosed steps. For example, even when some constituents or some steps are deleted from the whole constituents or the whole steps shown in each embodiment, problems described in the chapter Problems that the Invention is to Solve may be solved, and the effect described in the chapter Effect of the Invention may be obtained. In such a case, the configuration in which the constituents or the steps are deleted can be extracted as an aspect of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A personal identification system comprising:
a storage unit that stores previously registered personal information and biometric information of a user;
an input unit for inputting personal information and biometric information of the user;
a determination unit that determines whether or not the personal information input in the input unit coincides with the previously registered personal information stored in the storage unit;
a temporary cryptographic key generation unit that generates a temporary cryptographic key when the determination unit determines that the input personal information coincides with the previously registered personal information;
an encryption unit that encrypts, with the temporary cryptographic key, the biometric information input in the input unit to generate biometric information data;
a decryption unit that decrypts the biometric information data with the temporary cryptographic key into the biometric information; and
an identification unit that validates the decrypted biometric information with the previously registered biometric information to perform personal identification.

2. The personal identification system according to claim 1, wherein the previously registered personal information includes a user ID and a password.

3. The personal identification system according to claim 1, wherein the previously registered biometric information of the user is registered as biometric information feature extracted data obtained by extracting feature portions from the biometric information, the biometric information feature extracted data including a plurality of pieces of data for identifying at least one of a fingerprint, an iris, a voice and a face image of the user.

4. The personal identification system according to claim 1, further comprising an identification condition selecting unit that selects identification condition from the previously registered biometric information of the user.

5. The personal identification system according to claim 4, wherein the identification condition include a plurality of pieces of biometric information.

6. The personal identification system according to claim 1, further comprising a biometric information feature extraction unit that extracts feature portions from the biometric information input through the input unit to generate biometric information feature extracted data.

7. The personal identification system according to claim 6, wherein the encryption unit encrypts, with the temporary cryptographic key, the biometric information feature extracted data generated by the biometric information feature extraction unit.

8. A personal identification system comprising:
a server that performs personal identification based on biometric information of a user previously registered in a storage unit; and
an operation terminal that communicates with the server and is provided with an input unit to be operated by the user,
wherein the operation terminal encrypts biometric information of the user input through the input unit with a temporary cryptographic key that is transmitted from the server to generate encrypted data, and transmits the encrypted data to the server, and
wherein the server decrypts the encrypted data with the temporary cryptographic key, validates the decrypted biometric information with the previously registered biometric information to perform personal identification, and transmits a result of the personal identification to the operation terminal.

9. A personal identification method for performing personal identification based on previously registered personal information and biometric information of a user, the method comprising:
requesting to input personal information of the user in response to a personal identification request made by the user;
acquiring the personal information of the user;
determining whether or not the acquired personal information coincides with the previously registered personal information;
generating a temporary cryptographic key and determining identification conditions from among the previously registered biometric information when determined that the acquired personal information coincides with the previously registered personal information;
requesting to input biometric information conforming to the identification conditions;
acquiring the biometric information conforming to the identification conditions;
encrypting the acquired biometric information with the temporary cryptographic key to generate encrypted data;
decrypting the encrypted data with the temporary cryptographic key to acquire the biometric information; and
validating the decrypted biometric information with the previously registered biometric information to perform personal identification.

10. The personal identification method according to claim 9, wherein the previously registered personal information includes a user ID and a password.

11. The personal identification method according to claim 9, wherein the previously registered biometric information of the user is registered as biometric information feature extracted data obtained by extracting feature portions from the biometric information, the biometric information feature extracted data including a plurality of pieces of data for identifying at least one of a fingerprint, an iris, a voice and a face image of the user.

12. The personal identification method according to claim 9, wherein the identification condition include a plurality of pieces of biometric information.

13. The personal identification method according to claim 9, further comprising extracting feature portions from the acquired biometric information to generate biometric information feature extracted data.
